(19) United States
(12) Patent Application Publication
(10) Pub. No.: US 2026/0358664 A1
(43) Pub. Date: Nov. 12, 2026

(54) DUAL-DRIVE PHOTONIC PHASE-CONTROL DEVICES

(71) Applicant: Polaris Electro-Optics, Inc., Broomfield, CO (US)

(72) Inventors: Li-Yuan Chiang, San Diego, CA (US); Jason W. Sickler, Arlington, MA (US); Gianlorenzo Masini, Broomfield, CO (US)

(21) Appl. No.: 19/675,282

(22) Filed: May 12, 2026

Related U.S. Application Data
(60) Provisional application No. 63/804,609, filed on May 12, 2025.

(51) Int. Cl. G02F 1/1343; G02F 1/1337; G02F 1/141

(52) U.S. Cl. CPC G02F 1/13439; G02F 1/141; G02F 1/133711

(57) ABSTRACT

A dual-drive photonic phase-control device includes a substrate, a plurality of sidewalls defining a cavity over the substrate, a slot waveguide disposed on the substrate, a slot electrode, and a cavity electrode. The slot electrode is electrically configured and positioned to apply a modulating signal substantially perpendicularly across the slot waveguide. The cavity electrode is positioned at an upper region of the cavity opposite the slot electrode. The cavity electrode is electrically configured and positioned to deliver a modulating signal through the cavity from the cavity electrode to the slot waveguide.

### CROSS-REFERENCE TO RELATED APPLICATION

This application claims the benefit of U.S. Provisional Application No. 63/804,609, filed on 12 May 2025, the disclosure of which is incorporated herein by reference in its entirety.

### BACKGROUND

In the art of photonics, an optical modulator is a device that controls various properties or modes of a light beam, such as its intensity, phase, polarization, or the like. There are different types of optical modulators designed to control different aspects of such a light beam, including intensity modulators, phase modulators, and polarization modulators, to name a few. Phase modulators and phase shifters are examples of photonic devices that manipulate the phase of light as it passes through the device. In general, phase modulators are designed to change the phase of light over time in a continuous or discontinuous fashion, which can operate based on various physical mechanisms, such as via the Pockels effect, whereby the light phase is modulated by changing the refractive index of an optical medium using an applied electric field. Phase modulators are commonly used in applications where dynamic phase control is needed, such as beam steering, holography, and optical communications.

Phase shifters, on the other hand, generally refer to devices used to set a fixed phase shift in an optical signal by, for example, altering the refractive index of an optical medium through which the light propagates. Phase shifters are often used in integrated photonics platforms, such as silicon photonics, for applications like signal processing and interferometry. Additional examples of photonic integrated circuits include photonic integrated circuits that are used in worldwide communication networks, data center networks, optical computing, optical processing, artificial intelligence, quantum computing, satellite antennas, light detection and ranging (LIDAR), and many more applications. Within photonic integrated circuits, electro-optic modulators may be used to convert information between the electrical and optical fields. Phase shifters are thus capable of providing a stable and precise phase shift without the need for continuous adjustment or, in some cases, a slow and stable phase shift over time.

### SUMMARY OF THE EMBODIMENTS

In a first aspect, a dual-drive photonic phase-control device includes a substrate, a plurality of sidewalls defining a cavity over the substrate, a slot waveguide disposed on the substrate, a slot electrode, and a cavity electrode. The slot electrode is electrically configured and positioned to apply a modulating signal substantially perpendicularly across the slot waveguide. The cavity electrode is positioned at an upper region of the cavity opposite the slot electrode. The cavity electrode is electrically configured and positioned to deliver a modulating signal through the cavity from the cavity electrode to the slot waveguide.

### BRIEF DESCRIPTION OF THE DRAWINGS

FIG. 1 is a cross-sectional schematic of a dual-drive photonic phase-control device, in an embodiment.

FIG. 1A-1G, 2A-2D, 3A-3C are schematics of dual-drive photonic phase-control devices, which are examples of the device of FIG. 1.

FIGS. 4A and 4B show refractive index maps of a slot-waveguide modulator, which is an embodiment of the device of FIG. 1.

FIGS. 5A and 5B are refractive index maps of a slot-waveguide modulator, which is an embodiment of the device of FIG. 1.

FIGS. 6A, 6B, and 6C illustrate simulated electric field distributions in a device, which is an embodiment of the device of FIG. 1.

FIG. 7 includes SEM images of a fabricated device, which is an embodiment of the device of FIG. 1.

FIG. 8 shows a simulated TE0 mode of the device of FIG. 7.

FIG. 9 is a functional block diagram of an embodiment of a device that includes a dual-drive photonic phase-control device of FIG. 1, a slot modulator, and a cavity modulator.

FIG. 10 is a schematic plan view of an embodiment of an optical ring resonator that includes the dual-drive photonic phase-control device of FIG. 1.

FIG. 11 is a schematic plan view of an embodiment of a Mach-Zehnder modulator that includes the dual-drive photonic phase-control device of FIG. 1.

### DETAILED DESCRIPTION OF THE EMBODIMENTS

The art of silicon-organic hybrid (SOH) photonics utilizes the properties of electro-optic (EO) materials combined with traditional silicon-photonics technologies. EO materials are foundational to a broad range of technological areas of research and industry. EO materials change their optical properties in response to an applied electric field, which allows the EO materials to serve as an interface between electric fields and optical fields. In other words, devices may be built utilizing EO materials to convert electrical signals to optical signals. One area of SOH photonics that has been of significant research interest utilizes silicon-based materials to modulate optical properties of EO materials in associated slot waveguides.

One example of such a silicon-based modulator includes doped silicon rails that are separated by a sub-wavelength distance to form a slot. The slot is filled with an optical medium such as, for example, an EO material. In other examples, devices can include rails of a conductive or semiconductive material other than silicon, such as, for example, doped or undoped group III-V materials, including mixtures thereof, carbon conductive materials, including 2-D materials such as graphene, for example.

It is noted that high-speed Mach-Zehnder modulators are widely used for their capability to modulate optical signals. These intensity modulators, including two optical phase shifters, modulate optical intensity through optical interference. Precise optical phase control is important for maximizing the modulation effect and compensating for fabrication errors in Mach-Zehnder modulators. Traditionally, such precise optical phase control has been realized by including an additional electro-optic or thermo-optic phase shifter in the integrated circuit, which undesirably increases the footprint size of the integrated circuit on the chip to account for the extra phase shifter.

Embodiments disclosed herein include slot waveguide modulator devices that generally include rails separated by a sub-wavelength distance to form a slot therebetween. The slot and an area above the slot are filled with one or more EO materials. An electromagnetic signal concentrated within the one or more EO materials in the slot may be modulated by at least two separate modulation mechanisms according to the EO properties of the one or more EO materials to provide precise optical phase control. Such “slot waveguide modulators” thus generally include at least the rails separated by a sub-wavelength distance to form the slot, the one or more EO materials located in and above the slot, and a lower cladding layer underneath the rails.

In some examples, the slot waveguide modulator includes a slot modulator that delivers a first modulating signal substantially perpendicularly across the slot waveguide and a cavity modulator that delivers a second modulating signal across the cavity to the slot waveguide. The first and second modulating signals may be used to affect the EO properties of one or more EO materials in the slot and in the cavity, which thus forms the electromagnetic signal delivered through the slot waveguide.

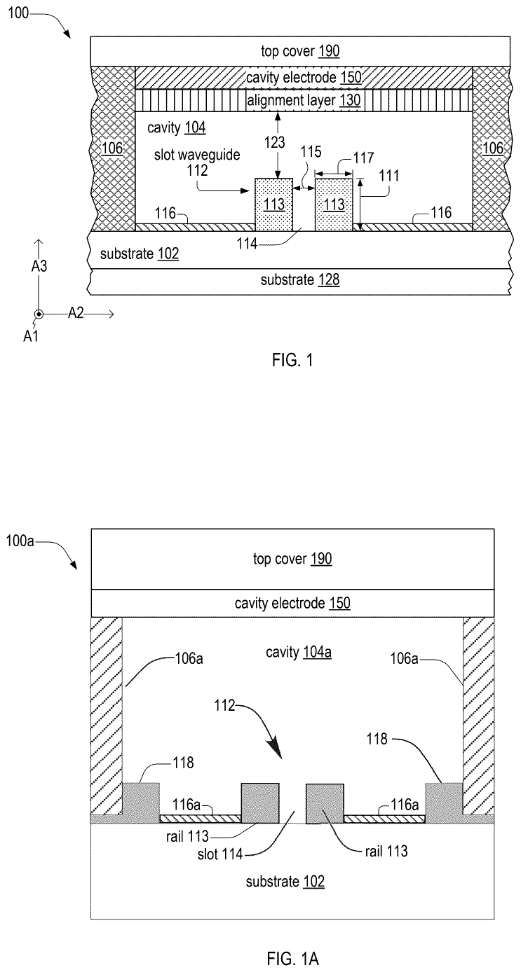

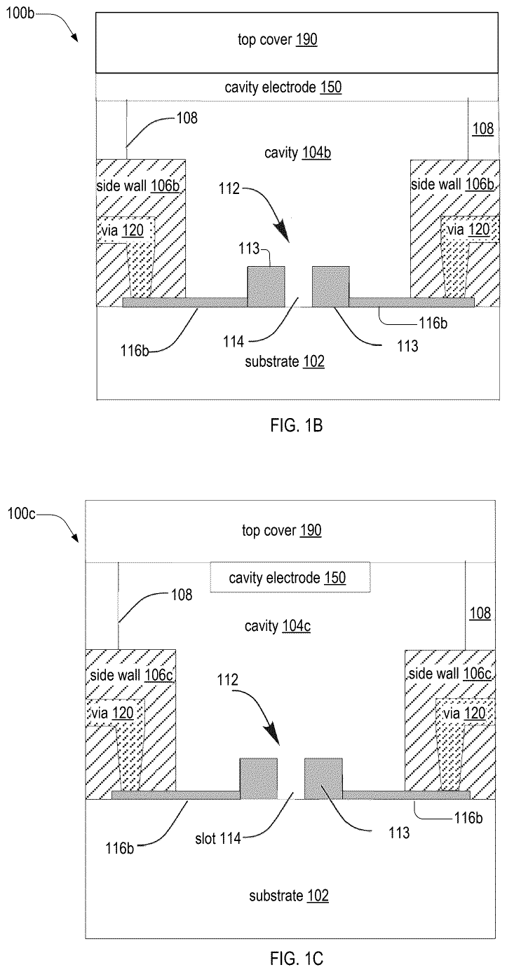

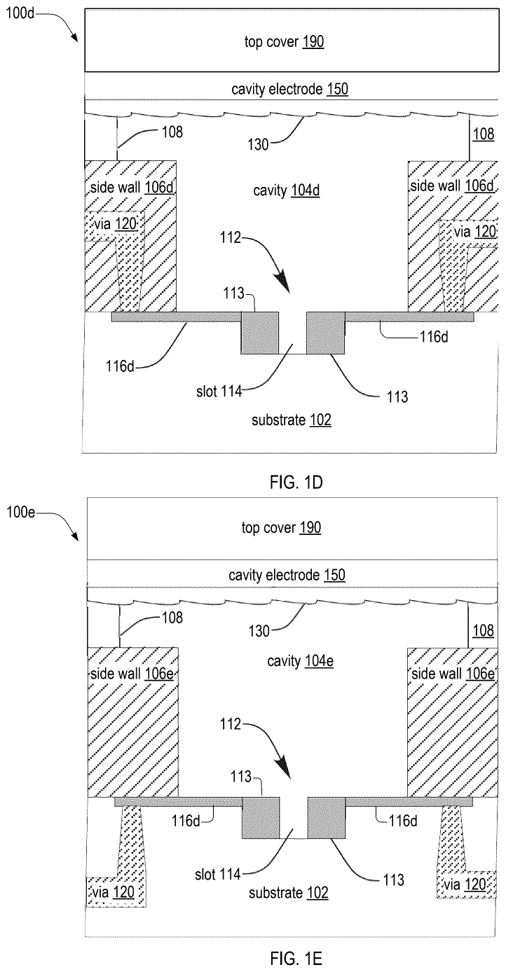

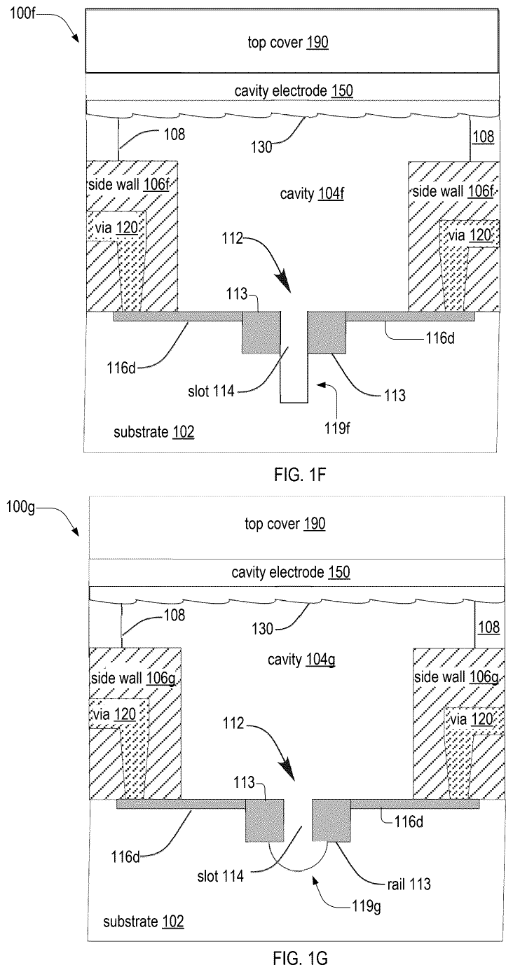

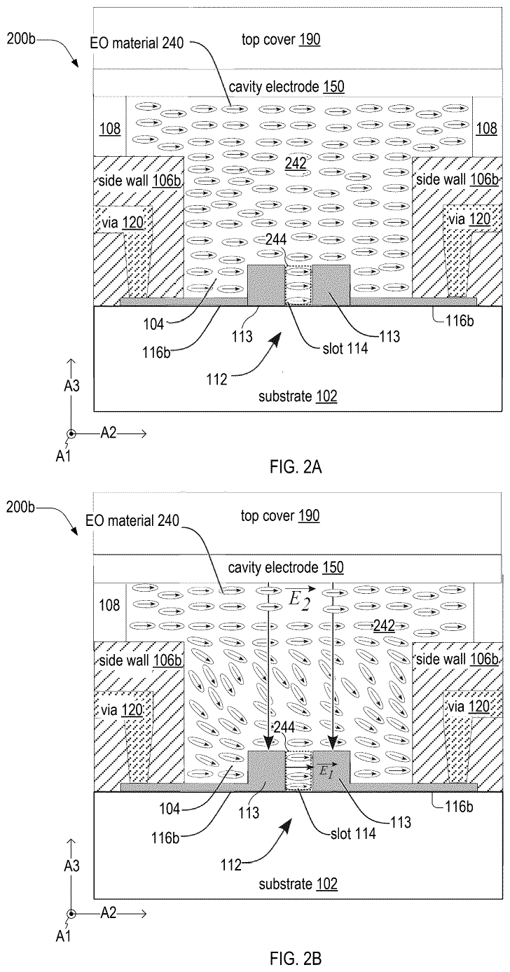

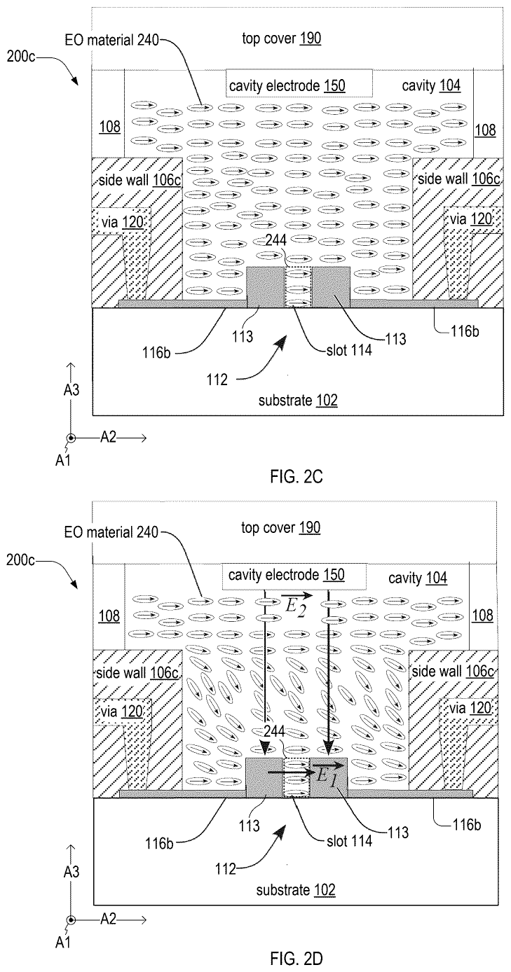

FIG. 1 is a cross-sectional schematic of a dual-drive photonic phase-control device 100, hereinafter device 100. As used herein, the term phase control refers to any intentional modification of an optical phase of an electromagnetic wave, including high-speed, time-varying phase modulation and low-speed or static phase shifting or phase trimming.

Device 100 includes at least one of a substrate 128, a substrate 102, sidewalls 106, one or more slot electrodes 116, rails 113, an alignment layer 130, a cavity electrode 150, and a top cover 190. Rails 113 form a slot waveguide 112, which functions as a slot waveguide. While device 100 and examples of device 100 disclosed herein are illustrated with two slot electrodes (e.g., slot electrode 116), each of said devices may include just one slot electrode without departing from the scope hereof.

Substrate 102 may include doped or undoped silicon. In some cases, substrate 102 is silicon dioxide, silicon nitride, or the like. In some cases, substrate 102 may comprise a plurality of layers. The plurality of layers may include one or more dielectric materials. In some cases, the plurality of layers comprises one or more electrically conductive materials.

In embodiments, substrate 102 is SiO₂ and underlying substrate 128 is silicon, such as amorphous silicon, crystalline silicon, microcrystalline silicon, and the like. It is additionally contemplated that the underlying substrate 128 may be a semiconductor layer or other functional layer in the device.

Sidewalls 106 at least partially define a cavity 104 over substrate 102. Cavity 104 may be filled with an EO material or other cladding material. Top cover 190 may be transparent and may span across sidewalls 106 to close cavity 104. Slot waveguide 112 is disposed on substrate 102 and extends longitudinally (parallel to axis A1) within cavity 104. Slot waveguide 112 includes a pair of adjacent rails 113, where the gap between slot rails 113 defines a slot 114. Slot waveguide 112 may include more than two rails.

Rails 113 may be made of any material that allows the described functionalities. In some cases, the rails may be formed of silicon, such as crystalline silicon, silicon nitride, doped silicon, and the like. In some cases, the height of each rail 113 is between 50 nanometers and 1,000 nanometers. In other cases, the height of each rail 113 is between 50 nanometers and 100 nanometers, between 50 nanometers and 200 nanometers, between 50 nanometers and 500 nanometers, between 50 nanometers and 1,000 nanometers, between 100 nanometers and 200 nanometers, between 100 nanometers and 500 nanometers, between 100 nanometers and 1,000 nanometers, between 200 nanometers and 500 nanometers, between 200 nanometers and 1,000 nanometers, or between 500 nanometers and 1,000 nanometers. In other cases, the height of each rail 113 is about 50 nanometers, about 100 nanometers, about 200 nanometers, about 500 nanometers, or about 1,000 nanometers. In other cases, the height of each rail 113 is at least about 50 nanometers, about 100 nanometers, about 200 nanometers, or about 500 nanometers. In other cases, the height of each rail 113 is at most about 100 nanometers, about 200 nanometers, about 500 nanometers, or about 1,000 nanometers.

Rail 113 has a width 117. In some cases, width 117 is between 30 nanometers and 800 nanometers. In other cases, width 117 is between 30 nanometers and 100 nanometers, between 30 nanometers and 200 nanometers, between 30 nanometers and 500 nanometers, between 30 nanometers and 800 nanometers, between 100 nanometers and 200 nanometers, between 100 nanometers and 500 nanometers, between 100 nanometers and 800 nanometers, between 200 nanometers and 500 nanometers, between 200 nanometers and 800 nanometers, or between 500 nanometers and 800 nanometers. In other cases, width 117 is about 30 nanometers, about 100 nanometers, about 200 nanometers, about 500 nanometers, or about 800 nanometers. In some cases, width 117 is at least about 30 nanometers, about 50 nanometers, about 100 nanometers, about 200 nanometers, or about 500 nanometers. In some cases, width 117 is at most about 100 nanometers, about 200 nanometers, about 500 nanometers, or about 800 nanometers.

In embodiments, rails 113 are spaced apart by a gap therebetween to form slot 114, which has depth 111 and a width 115, as shown in FIG. 1A. Depth 111 may be between 100 nm and 500 nm or between 200 nm and 300 nm. Example ranges of width 115 include between 10 nanometers and 500 nanometers, between 10 nanometers and 75 nanometers, between 10 nanometers and 100 nanometers, between 10 nanometers and 150 nanometers, between 10 nanometers and 300 nanometers, between 10 nanometers and 500 nanometers, between 75 nanometers and 100 nanometers, between 75 nanometers and 150 nanometers, between 75 nanometers and 300 nanometers, between 75 nanometers and 500 nanometers, between 100 nanometers and 150 nanometers, between 100 nanometers and 300 nanometers, between 100 nanometers and 500 nanometers, between 150 nanometers and 300 nanometers, between 150 nanometers and 500 nanometers, or between 200 nanometers and 500 nanometers. Width 115 may be about 20 nanometers, about 50 nanometers, about 75 nanometers, about 100 nanometers, about 150 nanometers, about 200 nanometers, about 300 nanometers, or about 500 nanometers. Width 115 may be at least about 20 nanometers, at least about 50 nanometers, about 75 nanometers, about 100 nanometers, about 150 nanometers, or about 200 nanometers. Width 115 may be at most about 75 nanometers, about 100 nanometers, about 150 nanometers, about 200 nanometers, about 300 nanometers, or about 500 nanometers.

Cavity electrode 150 and the top surface of slot waveguide 112 are separated by a distance 123. Distance 123 may be between 1 μm and 100 μm, for example, between 2 μm and about 10 μm.

Slot electrodes 116 are electrically configured and positioned to apply a modulating signal substantially perpendicularly across slot waveguide 112, e.g., in a direction parallel to axis A2. Cavity electrode 150 may be positioned at an upper region of cavity 104 opposite slot waveguide 112, whereby cavity electrode 150 is electrically configured and positioned to deliver a modulating signal through cavity 104 from cavity electrode 150 to slot electrodes 116.

Slot electrodes 116 and cavity electrode 150 may each independently be made of any type of electrically conductive material, including doped or undoped semiconductive materials, metals, and the like. In one example, the electrically conductive material is doped silicon. Substrate 102 and sidewalls 106 may each be independently made of any type of dielectric material capable of providing electrical isolation to prevent unwanted conduction pathways from cavity 104. In one example, substrate 102 and/or the sidewalls may be an oxide, such as silicon dioxide (SiO₂). In another example, cavity electrode 150 may be indium tin oxide (ITO).

FIG. 1A-1G are cross-sectional schematics of respective dual-drive photonic phase-control devices 100a, 100b, 100c, 100d, 100e, 100f, and 100g, each of which is an example of device 100. Devices 100a-100g include respective cavities 104a-104g, and sidewalls 106a-106g, which are respective examples of cavity 104 and sidewall 106. Device 100a may include one or more slot electrodes 116a; devices 100b and 100c have one or more slot electrodes 116b, and devices 100d-100g have one or more slot electrodes 116d. Each of slot electrodes 116a, 116b, and 116d is an example of slot electrode 116.

Device 100 may also include a side electrode electrically connected to slot electrode 116. For example, embodiments of device 100a include side electrodes 118, each of which may be electrically connected to a respective slot electrode 116a.

While devices 100a-100g differ in one or more aspects, features attributed to one of devices 100a-100g may be present in other devices 100a-100g. For example, only devices 100d and 100g are shown to include alignment layer 130, any one of devices 100 (that is, devices 100a-100g) may include an alignment layer 130. Similarly, while devices 100g and 100f are shown with a recessed region of substrate 102 beneath slot 114 resulting from overetching (to form slot 114), any of devices 100 may have said recessed region.

Device 100b includes a cavity 104b over substrate 102, cavity 104b being defined by a plurality of sidewalls 106b. A spacer 108 is disposed on the plurality of sidewalls 106b, at least in order to provide mechanical stability to the device, isolate cavity 104b from other cavities or areas outside of the cavity, and the like. In some examples, a top cover 190, which in some cases may be transparent, is coupled to the top of the device.

In embodiments, slot electrode 116, e.g., slot electrode 116b, is integrated into slot waveguide 112 by, for example, doping at least a portion of one or more of rails 113. A rail 113 and a slot electrode 116 may be integrally formed, and hence be different regions of a same layer and/or volume of material. Slot electrode 116b electrically couples rail 113 and a via 120 outside of cavity 104. Slot electrode 116b may contact a portion of slot waveguide 112 or may contact slot waveguide 112 along its full or substantially full length. In one example, slot electrode 116b is a conductive slab extending along the full length or substantially the full length of slot waveguide 112.

Slot electrode 116 and rail 113 may have different material compositions or identical material compositions. Slot electrode 116 may be formed of a metal, semiconductor materials (e.g., doped silicon), or the like. For example, slot electrode 116 may be made of aluminum, gold, copper, graphite, titanium, brass, silver, or platinum, or any combination thereof. Slot waveguide 112 may be connected to slot electrode 116 through silicon strip-loads, doped silicon slabs, silicide, vias, or the like.

In embodiments, cavity electrode 150 extends across only a portion of cavity 104c above slot waveguide 112, as in device 100c of FIG. 1C. Among other things, this cavity electrode configuration allows metallization lines to be more densely packed and highly integrated.

Device 100 may include alignment layer 130 on respective surfaces of cavity electrode 150 and/or top cover 190 that face substrate 102. For example, FIG. 1D shows device 100d, where cavity 104d includes alignment layer 130 positioned at an upper portion of cavity 104d below cavity electrode 150. Alignment layer 130 may be used to assist in aligning EO materials filling cavity 104d. This is particularly true of liquid crystals, but it is contemplated to use an alignment layer with EO polymers as well. Furthermore, FIG. 1D includes slot waveguide 112, which may be formed using any appropriate fabrication technique. In one example, slot waveguide 112 may be formed on a temporary substrate followed by deposition of substrate 102 thereupon. The temporary substrate can then be etched away to form cavity 104, which is then filled with an EO material.

In some cases, alignment layer 130 is a polymer. In other cases, alignment layer 130 is silicon dioxide. In further cases, the silicon dioxide may be obliquely deposited relative to an orientation of slot waveguide 112. In other cases, the polymer may be buffed polyimide. In further cases, the polymer may be a photoalignment polymer, such as Rolic AG.

FIG. 1E shows device 100e, which is similar to device 100d, wherein the vias 120 electrically couple to slot electrodes 116d through substrate 102. In embodiments, slot 114 is not overetched. FIGS. 1F and 1G show examples of respective devices 100f and 100g in which slot 114 has been overetched. Devices 100f and 100g have respective overetch regions 119f and 119g.

In embodiments, cavity 104 is at least partially filled with an EO material 240, which is shown in FIG. 2A-2D. EO material 240 may include one or more EO polymers.

EO material 240 may be a ferroelectric liquid crystal material, such as a ferroelectric nematic (FN) phase material. In yet other examples, the ferroelectric liquid crystal material is a ferroelectric smectic (FS) phase material. The remainder of the disclosure will use the phrase ferroelectric liquid crystal (FLC) for convenience, with the understanding that, where applicable, other EO materials are being considered.

FIGS. 2A and 2B are cross-sectional schematics of a dual-drive photonic phase-control device 200b, which is 100b with a ferroelectric liquid crystal in cavity 104b. FIGS. 2C and 2D are cross-sectional schematics of a dual-drive photonic phase-control device 200c, which is 100c with a EO material 240 in cavity 104c.

As noted, any of devices 100a-100g may have EO material 240 in its cavity 104. Devices 200b and 200c are illustrated here as examples. Accordingly and for the sake of describing embodiments of devices 100a-100g, the following description uses reference numbers without letter suffixes, e.g., device 200, cavity 104, and slot 114, the meaning of which should be interpreted as previously described.

Device 200 includes EO material 240 disposed in cavity 104. The following description denotes a volume of EO material 240 within slot 114 as slot EO material 244 and a volume of EO material 240 in cavity 104 and outside of slot 114 as cavity EO material 242. Accordingly, cavity EO material 242 and slot EO material 244 have the same material composition. Yet, their refractive indices may differ as a result of their being subject to different externally applied electric fields, such as by voltage across rails 113 or a voltage applied to cavity electrode 150. EO material 240 may have one or more of (a) a spontaneous polarization that exceeds 1 μC/cm² and a second-order nonlinear susceptibility χ⁽²⁾ that exceeds 5 pm/V.

Respective signals applied to rails 113 and cavity electrode 150 may have different modulation frequencies. A signal applied to rails 113, e.g., via slot electrodes 116, may be modulated by a rail signal that modulates the refractive index of slot EO material 244 via its second-order nonlinear susceptibility χ⁽²⁾ (Pockels effect). The frequency, or a frequency component, of the rail signal may exceed 10 MHz. A signal applied to cavity electrode 150 may have a lower frequency, e.g., less than 10 MHz, than that of the rail signal.

Device 200 may be part of an integrated photonic device, such as a resonator or an interferometer, which may be tuned by switching or changing the spontaneous polarization of EO material 240. Signals propagating in the photonic device may undergo electro-optic phase modulation in slot EO material 244 via a χ⁽²⁾ -mediated refractive-index change.

As stated, EO material 240 may be a ferroelectric liquid crystal. In the following description, the term “the FLC” applies to such embodiments and refers to EO material 240 generally, or to slot EO material 244, as will be clear from the context.

EO material 240 may be aligned in cavity 104 over slot waveguide 112 such that a director of the FLC is substantially perpendicular to a longitudinal axis of slot waveguide 112. The longitudinal axis is parallel to axis A1. Similarly, in some cases, the slot FLC may be aligned in slot 114 such that a director of the FLC is substantially perpendicular to the longitudinal axis of slot waveguide 112.

EO material 240 is shown in a rest state where the cavity and the slot electrodes are inactive. EO material 240 aligns spontaneously into a polar fluid with aligned dipoles in a direction such that a director of the FLC is substantially perpendicular to the longitudinal axis of slot waveguide 112. Such alignment is uniform, thermodynamically stable, and readily reproducible within an FLC domain without the need for large electrical field poling. Optically uniform monodomains of FLCs may be obtained over large areas, either by applying a small DC field or by alignment with a thin alignment layer (not shown). It is generally noted that, while the FLC aligns spontaneously into a polar fluid, the alignment direction is not necessarily perpendicular to the longitudinal axis of slot waveguide 112 in all cases.

The depiction of device 200c in FIG. 2C reflects just one possible initial condition presented for illustrative purposes. It should be understood that in practice, the dipoles of FLC within slot 114 may or may not be aligned horizontally in the initial condition. In some cases, such initial horizontal alignment may be facilitated through an additional processing step such as, for example, application of a DC bias. It is further noted that even in situations where the initial alignment of the FLC differs from the alignment shown in FIG. 2C, the functionality of dual-drive devices and/or device mechanisms described herein also applied to such variations.

FIG. 2B shows device 200b when slot 114 and cavity electrode 150 are delivering modulating signals. The effects vary depending on the nature of the delivered signals. In one example, which is not intended to be limiting, the modulating signals incorporate the optical phase control functionality directly into a high-speed modulator. In this case, two modulation mechanisms may be used simultaneously. The first modulation mechanism may be a high-speed modulation that is actuated with electric signals applied horizontally across slot 114, thus leveraging the refractive index changes (Pockels effect) induced in EO material 244 in slot 114. The second mechanism may be a low-speed modulation that is induced by an electric field applied between cavity electrode 150 and slot waveguide 112, which can control the molecular orientation of EO material 240 above slot 114 (e.g., cavity EO material 242) for optical phase tuning. Modulation based on molecular reorientations are typically slow but efficient due to the strong birefringence of the molecules.

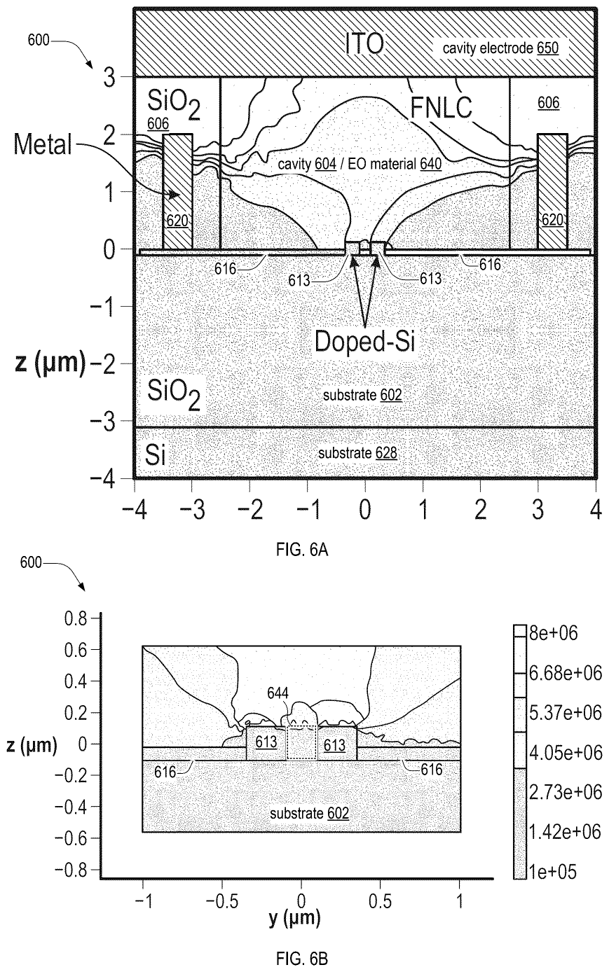

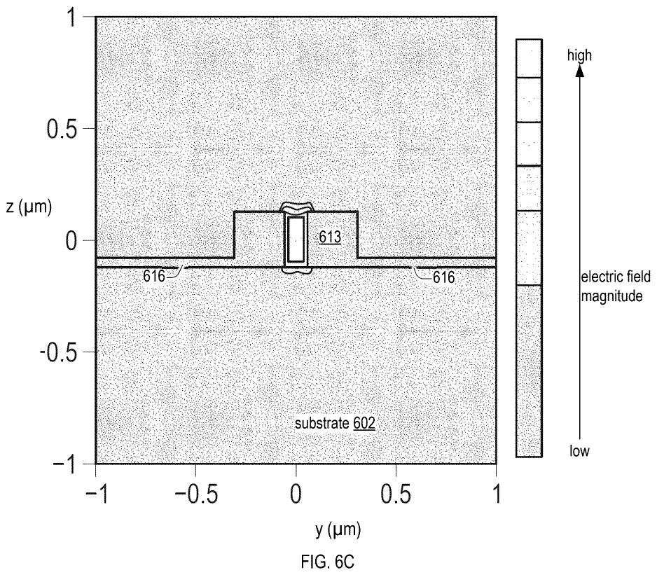

The molecular orientation inside slot 114 may be maintained with a DC bias from slot electrode 116, among other techniques. The vertical electric field from cavity electrode 150 for phase control does not affect the molecular orientation of slot EO material 244, as the vertical electric field is strongest above rails 113, which is outside slot 114. (See FIG. 6B, for example.) Compared to the alignment force inside slot 114, the reorientation force from cavity electrode 150 is small due to the relatively large vertical distance between cavity electrode 150 and slot waveguide 112.

FIG. 3A is a plan view of a dual-drive photonic phase-control device 300, which is an example of device 100. FIGS. 3B and 3C are cross-sectional views of devices 300b and 300c, respectively, which are examples of device 300. The cross-sectional views of FIGS. 3B and 3C are in a cross-sectional plane 302 of FIG. 3A. The plan cross-sectional view of FIG. 3A is from a cross-sectional plane 301 of FIGS. 3B and 3C within cavity 104 and toward substrate 102, and hence does not show a cavity electrode.

Device 300 includes two slot waveguides 112, slot electrodes 316, and at least one on-chip metal line 360. Slot electrode 316 is an example of slot electrode 116. Device 300 may also include optical couplers 371 and 372 coupled to each slot waveguide 112. In embodiments, optical coupler 371 equally splits an optical signal into each slot waveguide 112. Optical coupler 372 combines optical signals that exit slot waveguides 112. Each on-chip metal line 360 may be on substrate 102, and each may be electrically coupled to a respective slot electrode 116. One or both of optical couplers may be on substrate 102, and may be an integrated photonic device.

Devices 300b and 300c include respective cavity electrodes 350b and 350c, each of which is an example of cavity electrode 150. Each of slot waveguides 112 is directly below cavity electrode 350b. Cavity electrode 350c includes electrode elements 351 and 352, which are aligned above slot waveguides 112(1) and 112(2), respectively.

### Example 1: Simulation of Modulator Performance Optimization through Cladding Refractive Index Tuning

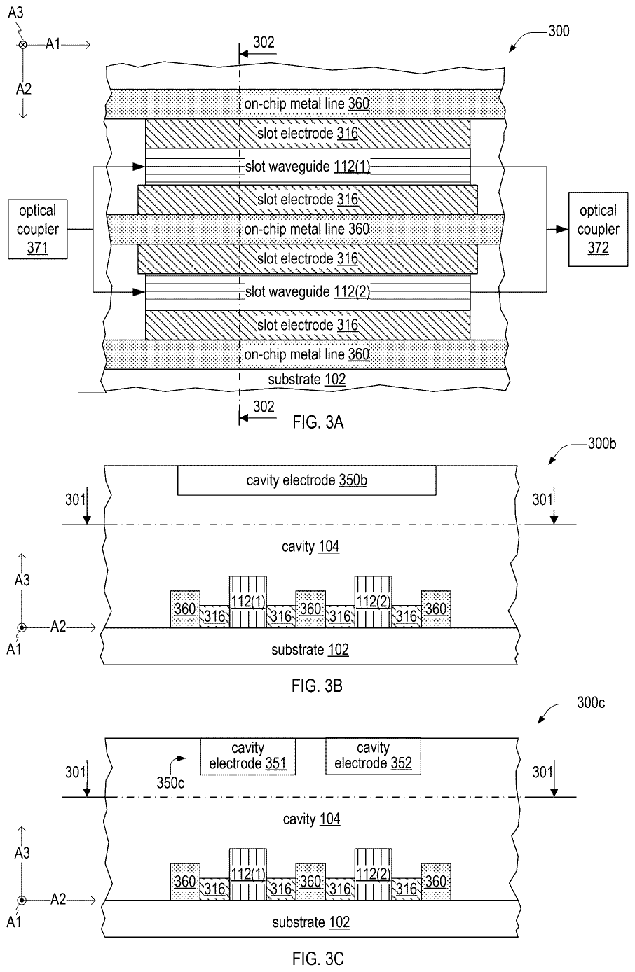

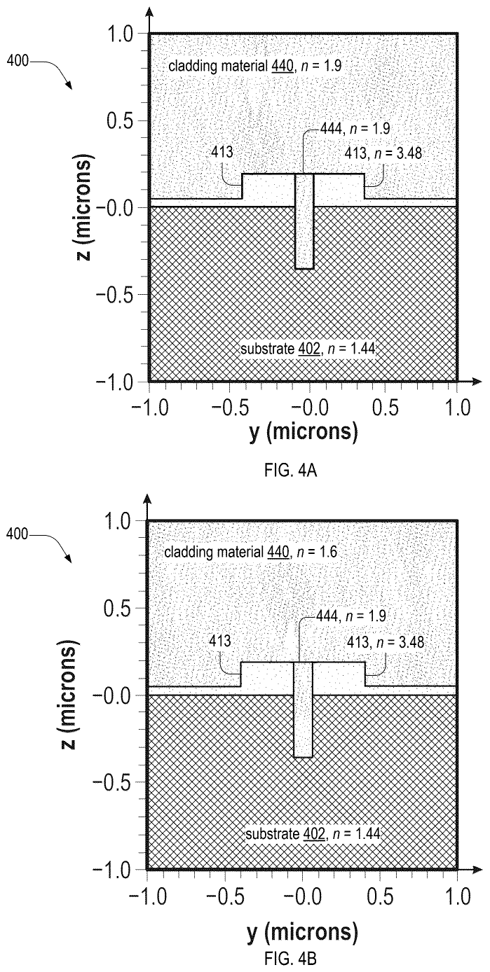

FIGS. 4A and 4B show refractive index maps of a slot-waveguide modulator 400, which is an example of device 100. Slot-waveguide modulator 400 includes a substrate 402, rails 413, a cladding material 440, and slot EO material 444, which are respective examples of substrate 102, rail 113, EO material 240, and slot EO material 244.

Cladding material 440 is in cavity 104 of modulator 400 and has an electro-optically tunable refractive index. Cladding material 440 has a refractive index n₄₄₁ and n₄₄₂ in FIGS. 4A and 4B, respectively. The difference in cladding indices n₄₄₁ and n₄₄₂ results from an electric field applied by cavity electrode 150. In the example of FIGS. 4A and 4B both refractive indices n₄₄₁ and n₄₄₂ are within the index tunability range of cladding material 440.

In a sample simulation, the modulation efficiency (V_{π}·L) through slot index modulation of slot waveguide modulator 400 with cladding index n₄₄₂ may be ~25% better (with smaller V_{π}·L) than in slot waveguide modulator 400 with cladding index n₄₄₁. This difference indicates a method of improving modulator performance by tuning the cladding refractive index from n₄₄₁ to n₄₄₂. FIGS. 4A and 4B show example refractive index values of substrate 402, slot rails 413, cladding material 440, and slot EO material 444. Said refractive index values may be at a visible or near-IR wavelength.

One application of the tuning described in FIGS. 4A and 4B is for use in a poling procedure of EO polymer modulators, which controls the refractive index of cladding material 440 during and after poling. Said tuning provides an additional degree of freedom in design and device operation to achieve improved modulation efficiency after poling.

Another application of such tuning is when cavity 104 is filled with one or more liquid crystal mixtures. The liquid crystal mixtures may be in the nematic phase, the ferroelectric nematic phase, or any other liquid crystal phase. The molecular orientations and therefore the EO properties of top cladding material 440 may be tuned via an electric field applied by cavity electrode 150. The electric field may be alternating current (AC) or direct current (DC), depending on the corresponding cavity liquid crystal mixture to be operated with.

### Example 2: Simulation of Slot Waveguide Modulation and Phase Trimming

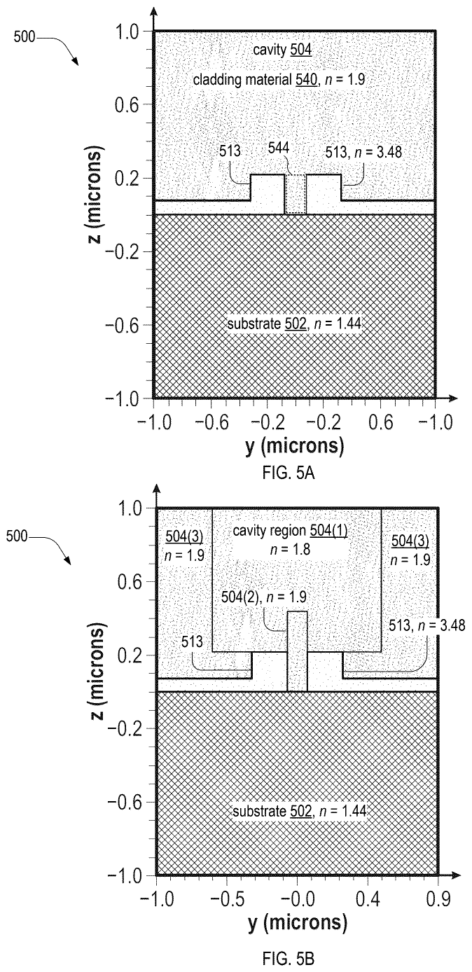

FIG. 5A is a refractive index map of a slot-waveguide modulator 500, which is an example of device 100. Slot-waveguide modulator 500 includes a substrate 502, cavity 504, rails 513, a cladding material 540, and slot EO material 544, which are respective examples of substrate 102, cavity 104, rails 113, EO material 240, and slot EO material 244. FIG. 5B schematically illustrates regions 504(1), 504(2), and 504(3) of cavity 504, in which the refractive index of cladding material 540 may differ in response to different externally applied electric fields being applied within cavity 504. Example values of these refractive indices are shown in FIG. 5B.

In FIG. 5A, modulator 500 is subject to high-speed modulation of slot EO material 544. Said modulation may be applied by slot electrodes 116. In FIG. 5B, modulator 500 is subject to low-speed modulation of cladding material 540 within cavity 104. Said modulation may be applied by cavity electrode 150.

Under the modulation of FIGS. 5A and 5B, an optical mode having a center has respective confinement factors Γₐ=Δn_{eff}/Δnₛₗₒₜ=0.16 and Γ_{b}=Δn_{eff}/Δn_{clad}=0.09. In the above expressions, Δnₛₗₒₜ is the refractive-index modulation of slot EO material 544, Δn_{clad} is the refractive-index modulation of cladding EO material 540 and Δn_{eff} is the optical mode index change in response to a material index modulation. The two models demonstrate the effectiveness of slot waveguide modulation and phase trimming through cladding index modulation, respectively, through tuning of slot EO material 544 or tuning of cladding material 540 outside of slot 114.

With one example of a device geometry, simulation results of slot modulation and cladding modulation are as follows: (a) 0.01 of Δnₛₗₒₜ can induce 0.0025 of Δn_{eff} (25%), and (b) 0.01 of Δn_{clad} can induce 0.0019 of Δn_{eff} (19%).

The two modulation mechanisms may be operated simultaneously. For example, the slot modulation functions as the high-speed modulation mechanism, while the cladding modulation serves as a phase trimming mechanism. The phase trimming mechanism facilitates precise phase tuning to optimize the operational point of the high-speed modulation along a Mach-Zehnder Modulator transfer function, thereby enhancing the modulation performance in response to the slot modulation.

### Example 3: Simulation of Electric Field Distribution with Top Cladding Index Modulation

FIGS. 6A, 6B, and 6C illustrate simulated electric field distributions in a dual-drive photonic phase-control device 600, which is an example of device 200. Device 600 includes silicon substrate 628, a silica substrate 602, cavity 604, silica sidewalls 606, doped silicon rails 613, slot electrodes 616, vias 620, EO material 640, slot EO material 644, and an ITO cavity electrode 650, which are respective examples of underlying substrate 128, substrate 102, cavity 104, sidewalls 106, rails 113, slot electrodes 116, vias 120, EO material 240, slot EO material 244, and cavity electrode 150.

The electric field distributions result from the application of a DC or AC voltage between ITO cavity electrode 650 and doped silicon rails 613, for the purpose of modulating the refractive index of EO material 640 in cavity 604. FIG. 6B provides an enlarged view of the slot waveguide region in FIG. 6A, emphasizing that the electric field is predominantly concentrated above rails 613. The field intensity within the slot region separating the two rails 613 is negligible, indicating that slot EO material 644 remains substantially unaffected during the cladding index modulation process.

FIG. 6C is a plot of a simulated electric field distribution of an applied (external) electric field when an external electric signal is applied across two slot waveguide electrodes 616. FIG. 6C shows that there is no observable electric field intensity in the silicon rails 613 and slot electrodes 616.

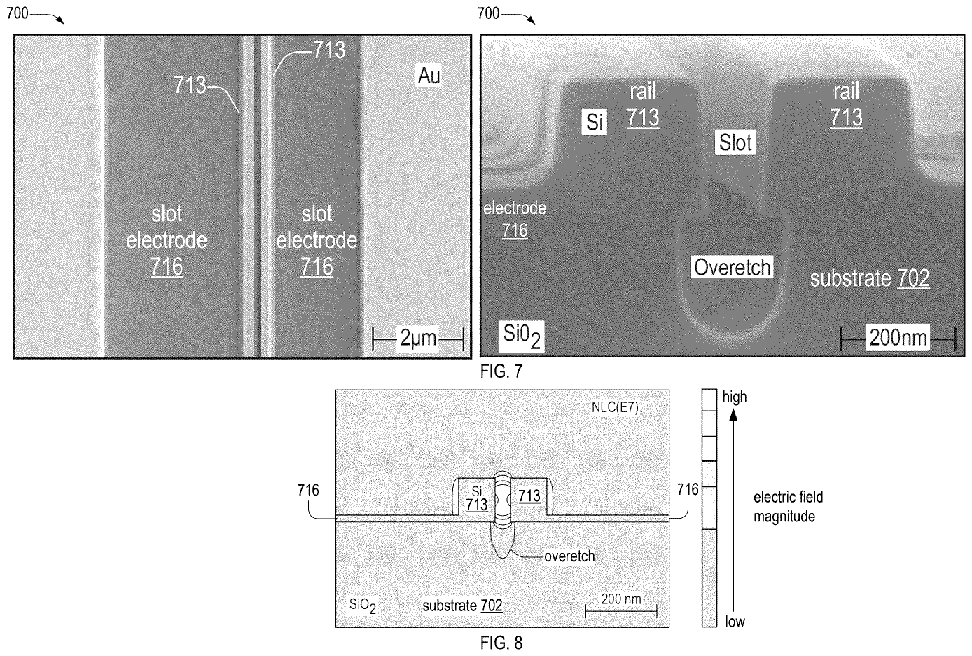

FIG. 7 includes SEM images of a fabricated dual-drive photonic phase-control device 700, which is an example of device 100. Device 700 includes a silica substrate 702, silicon rails 713, and gold slot electrodes 716, which are respective examples of substrate 102, rails 113, and slot electrodes 116. FIG. 8 shows a simulated TE₀ mode of device 700, where low-density dot patterns and high-density dot patterns correspond to high and low electric-field magnitudes, respectively.

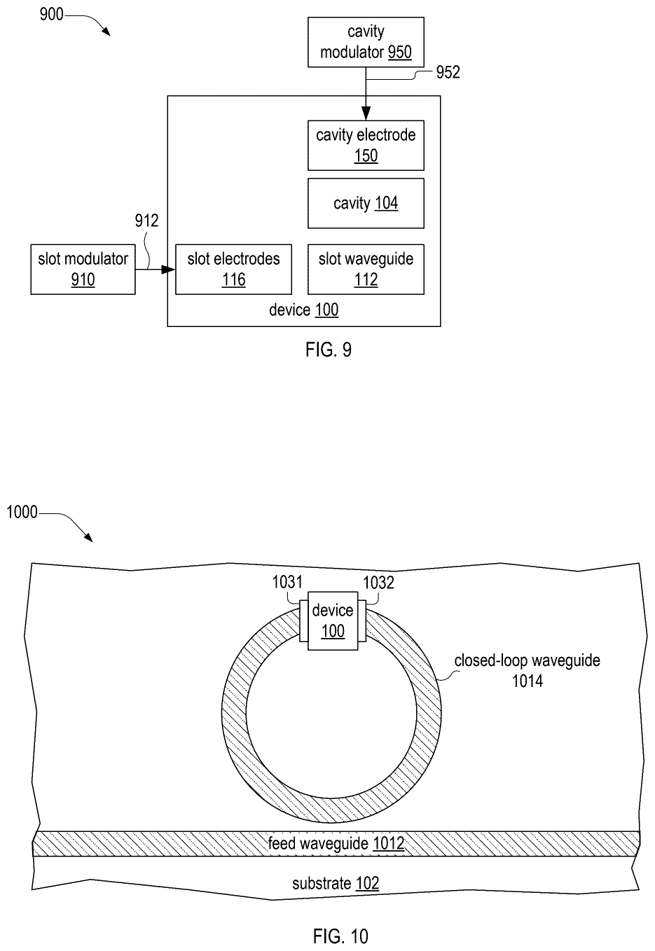

FIG. 9 is a functional block diagram of a device 900, which includes dual-drive photonic phase-control device 100, a slot modulator 910, and a cavity modulator 950. Slot modulator 910 is electrically coupled to slot electrodes 116 and configured to transmit a modulating signal 912 to slot electrode 116. Device 900 may include multiple slot electrodes 116, in which case each slot modulator 910 may be electrically connected to a respective slot electrode 116 and transmit a respective modulating signal thereto. Signal 912 may be modulated at a frequency greater than 10 MHz.

Cavity modulator 950 is electrically coupled to cavity electrode 150 and configured to transmit a modulating signal 952 to cavity electrode 150. Signal 952 may be modulated at a frequency less than 10 MHz.

One or both of slot modulator 910 and cavity modulator 950 may be on substrate 102. Examples of slot modulator 910 include driver circuits, an on-chip pulse generator, an RF signal source, and a MOSFET, and a Pockels cell driver. Examples of cavity modulator 950 include a bias controller, a signal generator, a DAC-based control circuit, a control loop circuit, and a bias-tee.

FIG. 10 is a schematic plan view of an optical ring resonator 1000, which includes a feed waveguide 1012, closed-loop waveguide 1014, device 100, an input coupler 1031, and an output coupler 1032, each of which may be formed on substrate 102. Closed-loop waveguide 1014 is evanescently coupled to feed waveguide 1012. Input coupler 1031 optically couples waveguide 1014 to slot waveguide 112. Output coupler 1032 optically couples slot waveguide 112 to waveguide 1014.

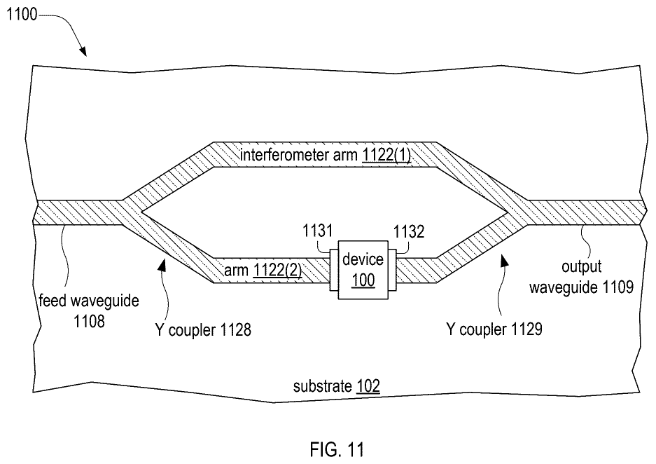

FIG. 11 is a schematic plan view of a Mach-Zehnder modulator 1100, which may be an integrated photonic device formed on substrate 102. Mach-Zehnder modulator 1100 includes Y-couplers 1128 and 1129, an interferometer arm 1122(1), an interferometer arm 1122(2), device 100, an input coupler 1131, and an output coupler 1132. Y-coupler 1128 couples a feed waveguide 1108 to each interferometer arm 1122. Y-coupler 1129 couples each interferometer arm 1122 to an output waveguide 1109. Input coupler 1131 optically couples either interferometer arm 1122(2) or a branch of Y-coupler 1128 to slot waveguide 112. Output coupler 1132 optically couples slot waveguide 112 to either interferometer arm 1122(2) or to a branch of Y-coupler 1129. Couplers 1031, 1032, 1131, and 1132 may be a ridge-to-slot (or slot-to-ridge) waveguide coupler, such as one that includes an adiabatic taper or inverse adiabatic taper.

Features described above, as well as those claimed below, may be combined in various ways without departing from the scope hereof. The following enumerated examples illustrate some possible, non-limiting combinations. The enumerated combinations include parenthetical numbers following selected terms. The parenthetical number indicates that the element associated with the number in parentheses is an example of the term. For example, embodiment 1 recites “a dual-drive photonic phase-control device (100),” which means that device 100 of FIG. 1 is an example of the dual-drive photonic phase-control device introduced in embodiment 1.

Embodiment 1. A dual-drive photonic phase-control device (100) includes a substrate (102), a plurality of sidewalls (106) defining a cavity (104) over the substrate, a slot waveguide (112) disposed on the substrate, a slot electrode (116), and a cavity electrode (150). The slot electrode is electrically configured and positioned to apply a modulating signal substantially perpendicularly across the slot waveguide. The cavity electrode is positioned at an upper region of the cavity opposite the slot electrode. The cavity electrode is electrically configured and positioned to deliver a modulating signal through the cavity from the cavity electrode to the slot waveguide.

Embodiment 2. The device of embodiment 1, further comprising: an electro-optic material (240) disposed in the cavity and including an electro-optic cavity material (242) disposed in the cavity; and an electro-optic slot material (244) disposed in the slot waveguide.

Embodiment 3. The device of either one of embodiments 1 or 2, wherein the electro-optic cavity material is oriented in the cavity with a director of the electro-optic material being substantially perpendicular to a longitudinal axis of the slot waveguide.

Embodiment 4. The device of either one of embodiments 2 or 3, wherein the electro-optic slot material is oriented in the slot waveguide with a director of the electro-optic slot material being substantially perpendicular to a longitudinal axis of the slot waveguide.

Embodiment 5. The device of any one of embodiments 1-4, wherein the slot waveguide comprises a pair of adjacently positioned slot rails (113) extending longitudinally on the substrate and spaced apart by a gap to form a slot.

Embodiment 6. The device of embodiment 5, wherein a width (115) of the gap between the adjacently positioned slot rails is between 5 nm and 800 nm, between 10 nm and 500 nm, between 20 nm and 250 nm, between 30 nm and 100 nm or between 40 nm and 80 nm.

Embodiment 7. The device of either one of embodiments 5 or 6, wherein a depth (111) of the gap from upper edges of the slot rails to a bottom of the gap in the slot waveguide is between 100 nm and 500 nm or between 200 nm and 300 nm.

Embodiment 8. The device of any one of embodiments 5-7, wherein the slot rails include materials selected from monocrystalline silicon, polycrystalline silicon, amorphous silicon, doped or undoped silicon, metals, group III-V materials, graphene-silicon hybrids, or combinations thereof.

Embodiment 9. The device of any one of embodiments 2-8, further comprising an alignment layer (130) contacting and assisting in alignment of the electro-optic material.

Embodiment 10. The device of any one of embodiments 2-9, wherein the electro-optic material is selected from a ferroelectric nematic phase material, a ferroelectric smectic phase material, an electro-optic polymer, or a combination thereof.

Embodiment 11. The device of any one of embodiments 2-10, wherein the electro-optic material is a ferroelectric nematic phase material.

Embodiment 12. The device of any one of embodiments 2-11, wherein the electro-optic slot material and the electro-optic cavity material are the same electro-optic material.

Embodiment 13. The device of any one of embodiments 2-12, wherein the electro-optic slot material and the electro-optic cavity material are different electro-optic materials.

Embodiment 14. The device of any one of embodiments 1-13, wherein the slot electrode is a doped portion of at least one slot rail of the slot waveguide.

Embodiment 15. The device of any one of embodiments 1-14, wherein the slot electrode is a non-silicon-based material electrically coupled to the slot waveguide.

Embodiment 16. The device of any one of embodiments 1-15, further comprising a planar silicon layer (116) extending laterally across the substrate from at least one sidewall of the slot waveguide, wherein the planar silicon layer is electrically conductive and positioned to provide electrical contact from outside the cavity to the slot electrode.

Embodiment 17. The device of any one of embodiments 1-16, further comprising a slot modulator (910) and a cavity modulator (950). The slot modulator is electrically coupled to the slot electrode and configured to transmit a first modulating signal to the slot electrode. The cavity modulator is electrically coupled to the cavity electrode and configured to transmit a second modulating signal to the cavity electrode.

Embodiment 18. The device of embodiment 17, further comprising an additional slot electrode, the slot modulator being electrically coupled to the additional slot electrode and configured to transmit the first modulating signal thereto.

Embodiment 19. The device of either one of embodiments 16 or 17, the first modulating signal having a modulation frequency exceeding 10 MHz, the second modulating signal having a modulation frequency less than 10 MHz.

Changes may be made in the above methods and systems without departing from the scope of the present embodiments. It should thus be noted that the matter contained in the above description or shown in the accompanying drawings should be interpreted as illustrative and not in a limiting sense. Herein, and unless otherwise indicated the phrase “in embodiments” is equivalent to the phrase “in certain embodiments,” and does not refer to all embodiments.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

The term “coupled” as used herein includes both direct coupling and indirect coupling through an intermediate layer or layers. Thus, for example, when referring to a doped semiconductor layer being coupled to a crystalline semiconductor layer, it may be directly coupled thereto, or through an intermediate layer.

As used herein, the term “about” is used to provide flexibility to a given term, metric, value, range endpoint, or the like. The degree of flexibility for a particular variable can be readily determined by one skilled in the art. However, unless otherwise expressed, the term “about” generally provides flexibility of less than 1%, and in some cases, less than 0.01%. It is to be understood that, even when the term “about” is used in the present specification in connection with a specific numerical value, support for the exact numerical value recited apart from the “about” terminology is also provided.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 1.5, 2, 2.3, 3, 3.8, 4, 4.6, 5, and 5.1 individually.

As used herein, when a component (e.g., a layer) is described as including a chemical element, compound, or material, the description refers to the presence of that element, compound, or material in the material composition of the component, without excluding the presence of additional elements, compounds, or materials.

Selected figures herein depict orthogonal axes A1, A2, and A3. Unless otherwise specified, heights and depths of objects herein refer to the object's extent along axis A3. Also, herein, a horizontal plane (or horizontal direction) is parallel to the A1-A2 plane, a width refers to an object's extent along axis A1 or axis A2, and a vertical direction is along axis A3.

As used in this specification, any appendices thereto, and the appended claims, the singular forms “a,” “an,” and “the” include plural referents unless the content clearly dictates otherwise. It should also be noted that the term “or” is generally employed in its sense including “and/or” unless the content clearly dictates otherwise. Regarding instances of the terms “and/or” and “at least one of,” for example, in the cases of “A and/or B,” “at least one of A and B,” and “at least one of A or B,” such phrasing encompasses the selection of (i) A only, or (ii) B only, or (iii) both A and B. In the cases of “A, B, and/or C, ” “at least one of A, B, and C,” and “at least one of A, B, or C,” such phrasing encompasses the selection of (i) A only, or (ii) B only, or (iii) C only, or (iv) A and B only, or (v) A and C only, or (vi) B and C only, or (vii) each of A and B and C. This may be extended for as many items as are listed.

The following claims are intended to cover all generic and specific features described herein, as well as all statements of the scope of the present method and system, which, as a matter of language, might be said to fall therebetween.

What is claimed is:

1. A dual-drive photonic phase-control device, comprising:
a substrate;
a plurality of sidewalls defining a cavity over the substrate;
a slot waveguide disposed on the substrate;
a slot electrode electrically configured and positioned to apply a modulating signal substantially perpendicularly across the slot waveguide; and
a cavity electrode positioned at an upper region of the cavity opposite the slot electrode, the cavity electrode being electrically configured and positioned to deliver a modulating signal through the cavity from the cavity electrode to the slot waveguide.

2. The device of claim 1, further comprising an electro-optic material, disposed in the cavity, and including an electro-optic cavity material outside the slot waveguide and an electro-optic slot material within the slot waveguide.

3. The device of claim 2, wherein the electro-optic cavity material is oriented in the cavity with a director of the electro-optic material being substantially perpendicular to a longitudinal axis of the slot waveguide.

4. The device of claim 2, wherein the electro-optic slot material is oriented in the slot waveguide with a director of the electro-optic slot material being substantially perpendicular to a longitudinal axis of the slot waveguide.

5. The device of claim 1, wherein the slot waveguide comprises a pair of adjacently positioned slot rails extending longitudinally on the substrate and spaced apart by a gap to form a slot.

6. The device of claim 5, wherein the gap between the adjacently positioned slot rails is between 5 nm and 800 nm, between 10 nm and 500 nm, between 20 nm and 250 nm, between 30 nm and 100 nm or between 40 nm and 80 nm.

7. The device of claim 5, wherein a depth of the gap from upper edges of the slot rails to a bottom of the gap in the slot waveguide is between 100 nm and 500 nm or between 200 nm and 300 nm.

8. The device of claim 5, wherein the slot rails include materials selected from monocrystalline silicon, polycrystalline silicon, amorphous silicon, doped or undoped silicon, metals, group III-V materials, graphene-silicon hybrids, or combinations thereof.

9. The device of claim 2, further comprising an alignment layer contacting and assisting in alignment of the electro-optic material.

10. The device of claim 2, wherein the electro-optic material is selected from a ferroelectric nematic phase material, a ferroelectric smectic phase material, an electro-optic polymer, or a combination thereof.

11. The device of claim 2, wherein the electro-optic material is a ferroelectric nematic phase material.

12. The device of claim 2, wherein the electro-optic slot material and the electro-optic cavity material are the same electro-optic material.

13. The device of claim 2, wherein the electro-optic slot material and the electro-optic cavity material are different electro-optic materials.

14. The device of claim 1, wherein the slot electrode is a doped portion of at least one slot rail of the slot waveguide.

15. The device of claim 1, wherein the slot electrode is a non-silicon-based material electrically coupled to the slot waveguide.

16. The device of claim 1, further comprising a planar silicon layer extending laterally across the substrate from at least one sidewall of the slot waveguide, wherein the planar silicon layer is electrically conductive and positioned to provide electrical contact from outside the cavity to the slot electrode.

17. The device of claim 1, further comprising:
a slot modulator electrically coupled to the slot electrode and configured to transmit a first modulating signal to the slot electrode; and
a cavity modulator electrically coupled to the cavity electrode and configured to transmit a second modulating signal to the cavity electrode.

18. The device of claim 1, further comprising an additional slot electrode, the slot modulator being electrically coupled to the additional slot electrode and configured to transmit the first modulating signal thereto.

19. The device of claim 17, the first modulating signal having a modulation frequency exceeding 10 MHz, the second modulating signal having a modulation frequency less than 10 MHz.
